(19) United States
(12) Patent Application Publication
(10) Pub. No.: US 2011/0068635 A1
(43) Pub. Date: Mar. 24, 2011

(54) MEDIUM OR HIGH VOLTAGE SWITCHGEAR APPARATUS AND METHOD OF EARTHING

(75) Inventors: Pavel Vrbka, Nedvedice (CZ); Emil Michlicek, Brno (CZ)

(73) Assignee: ABB Technology AG, Zurich (CH)

(21) Appl. No.: 12/887,558

(22) Filed: Sep. 22, 2010

(30) Foreign Application Priority Data
Sep. 23, 2009 (EP) 09466020.6

(51) Int. Cl. H02B 1/24

(52) U.S. Cl. 307/112

(57) ABSTRACT

A method of earthing two current inlet/outlet systems in a medium or high voltage switchgear using one circuit breaker comprises the following steps: a) switching OFF the circuit breaker; b) connecting the circuit breaker to the first current inlet/outlet system as well as to the earthing; c) switching the circuit breaker ON; d) providing a direct connection between the first current inlet/outlet system and the earthing via a connecting element; e) switching the circuit breaker OFF; f) disconnecting the circuit breaker at least from the first current inlet/outlet system; g) connecting the circuit breaker to the second current inlet/outlet system and to the earthing; and h) switching the circuit breaker ON. A switchgear apparatus to be used for said method is described as well.

### CROSS REFERENCE TO RELATED APPLICATION

This application claims priority under 35 U.S.C. §119(a)-(d) to European Patent Application Number 09466020.6, filed on Sep. 23, 2009, the entire contents of which are hereby incorporated by reference.

1. Field of the Invention

The invention relates to a medium or high voltage switchgear apparatus as well as to a method of earthing two current inlet/outlet systems in a medium or high voltage switchgear apparatus using one circuit breaker.

2. Description of the Prior Art

Medium or high voltage switchgear apparatuses are used in electric power systems to make and break connection between two current inlet/outlet systems and to earth any or both of the two current inlet/outlet systems as necessary. In this specification, the term “earth” or “earthing contact” stands for a point having substantially the same or almost the same electrical potential as that of earth or ground.

The above mentioned apparatuses usually comprise the two current inlet/outlet systems, at least one earthing contact and at least one circuit breaker. Circuit breakers are used in making the connection between two medium or high voltage electrical systems to avoid an arc between the two systems upon bringing the connectors of the system near to each other.

If there is only one circuit breaker the two current inlet/outlet systems in a medium or high voltage switchgear are earthed in the following steps: the circuit breaker is switched OFF and connected to the first current inlet/outlet system and to the earthing contact; then the circuit breaker is switched ON so that the first current inlet/outlet system is earthed.

Subsequently the circuit breaker might be switched OFF, disconnected from the first current inlet/outlet system (and optionally from the earthing contact) and used for earthing the second current inlet/outlet system in a similar way. However the maintenance of the apparatus earthed in such a way would be hazardous for the operating personal because of possible stray voltages in the first current inlet/outlet system which is no more connected to the earthing contact. Therefore an additional circuit breaker or earthing switch is used for earthing the second current inlet/outlet system after the first current inlet/outlet system has been earthed by the first circuit breaker. Of course, such additional apparatuses raise costs as well as space requirements for said switchgear and the earthing process in the switchgear is slowed down by the process of preparing and coupling of the additional earthing switch, respectively a second circuit breaker.

### SUMMARY OF THE INVENTION

A method of earthing a first and a second current inlet/outlet systems in a medium or high voltage switchgear comprising a circuit breaker, wherein the method has the following steps:
a) switching OFF the circuit breaker;
b) connecting the circuit breaker to the first current inlet/outlet system as well as to an earthing contact;
c) switching the circuit breaker ON;
d) providing a direct connection between the first current inlet/outlet system and an earthing contact via a connecting element;
e) switching the circuit breaker OFF;
f) disconnecting the circuit breaker at least from the first current inlet/outlet system;
g) connecting the circuit breaker between the second current inlet/outlet system and an earthing contact; and
h) switching the circuit breaker ON.

A medium or high voltage switchgear apparatus for making and breaking connection between a first and a second current inlet/outlet system. The apparatus has a casing, inside which a first current inlet/outlet system, a second current inlet/outlet system, one or more earthing contacts and a circuit breaker are disposed. The circuit breaker is movable relative to the first and to the second current inlet/outlet system to a position in which the circuit breaker is connected between the first current inlet/outlet system and the second current inlet/outlet system, to another position in which the circuit breaker is connected between the first current inlet/outlet system and one of the earthing contacts, and to yet another position in which the circuit breaker is connected between the second current inlet/outlet system and one of the earthing contacts. The apparatus further has a movable connecting element for making a connection between the first current inlet/outlet system and one of the earthing contacts when the circuit breaker is switched ON and connected between the first current inlet/outlet system and one of the earthing contacts and for keeping the connection after the circuit breaker has been switched OFF and disconnected at least from the second current inlet/outlet system.

### DESCRIPTION OF THE DRAWING

FIGS. 1 through 6 show the successive steps of the operation of the switchgear apparatus according to the invention. To enhance the clarity of FIGS. 1 through 6 the reference numerals have not been inserted in FIGS. 2 through 6.

FIG. 7 is a schematic side view of a preferred embodiment of the connecting element.

### DETAILED DESCRIPTION

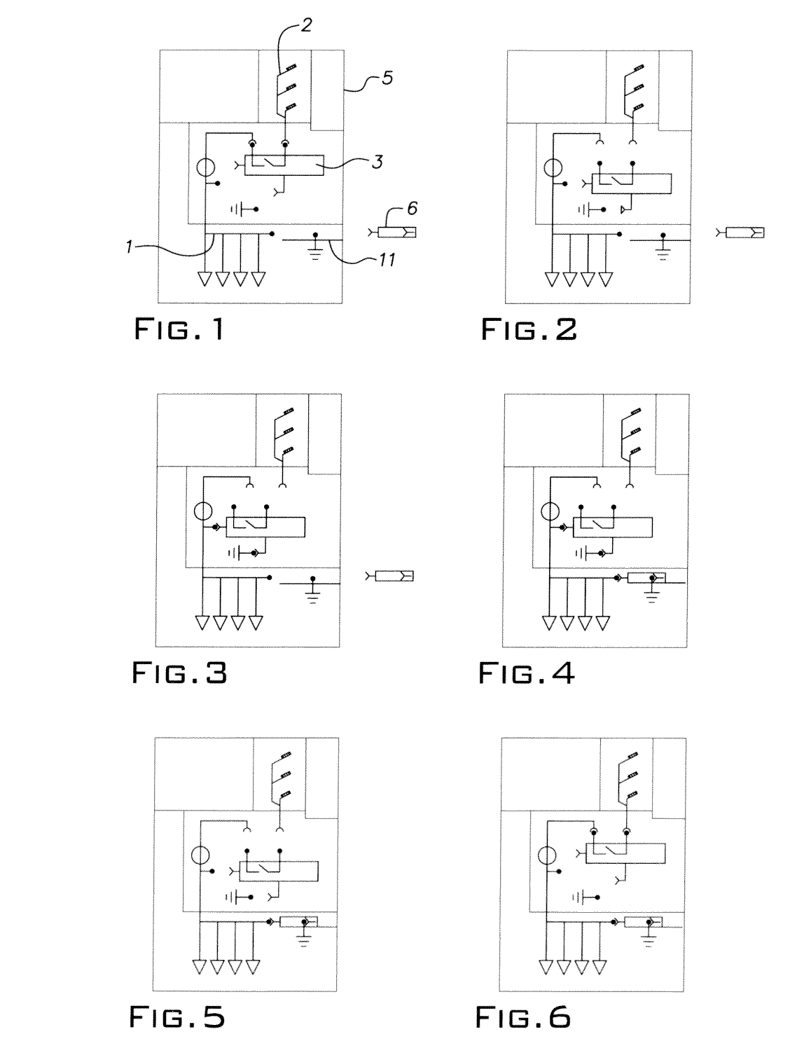

As mentioned above FIGS. 1 through 6 illustrate the method of earthing cables and busbars in a switchgear apparatus which is intended for making and breaking connection between a first current inlet/outlet system 1, e.g. cables, and a second current inlet/outlet system 2, e.g. busbars with tee-offs, using a circuit breaker 3. Vacuum interruptors, air circuit breakers, breakers filled with sulfur hexafluorid gas and other suitable circuit breakers may be used for circuit breaker 3.

In the embodiment illustrated the switchgear comprises a casing 5 inside which the first current inlet/outlet system 1 and the second current inlet/outlet system 2 are fixed. There is a circuit breaker 3 movably arranged inside the casing 5. Two opposite side walls of the casing 5 are provided with a pair of parallel guiding rails 11 arranged so as to guide a connecting element 6 when moving to or from a connection with the first current inlet/outlet system 1.

If the cables are to be disconnected from the busbar, the circuit breaker 3 is switched OFF so that the connection between the cables and the busbars is interrupted (FIG. 1) and the circuit breaker 3 is moved to be disconnected from the cables as well as from the busbars (FIG. 2).

To earth the cables, the circuit breaker 3 (switched OFF) is moved to be connected to the cables and to an earthing contact (FIG. 3). Then the circuit breaker 3 is switched ON and thus the cables are earthed.

To earth the busbars as well, first the connecting element 6 is moved into the casing 5 using the rails 11 for guiding the connecting element 6 inside the casing 5 until the connecting element 6 is connected to the cables and to an earthing contact and the connecting element 6 is locked in that position by means of a locking device in order to prevent any movement of the connecting element 6 out of that position.

Because the cables have been earthed before the connecting element has approached the cables, there is no risk of an arc occurrence when making said connection so that the connecting element does not need to be a special circuit breaker or earthing switch. Then the circuit breaker 3 is switched OFF, while the cables are still earthed via the connecting element 6 (FIG. 4) and the circuit breaker is moved to be disconnected from the cables and from the earthing contact (FIG. 5).

Finally, the circuit breaker (switched OFF) is moved to be connected to the busbars and then it is switched ON (FIG. 6), so that both the cables as well as the busbars are earthed. Now, the operating personnel may attend to any required maintenance or repair services without any risk of being injured by short time currents or any residual voltage etc.

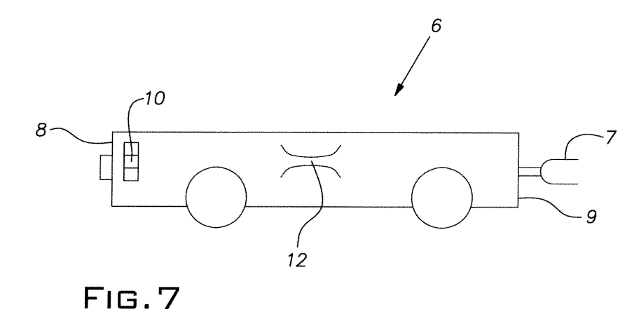

As shown in FIG. 7, a preferred embodiment of the connecting element 6 comprises a frame having a front part 9, a back part 8 and two side walls, wherein there are three contact pieces 7 at the front part 9 of the connecting element 6 for connecting the connecting element 6 to the first current inlet/outlet system 1. There is a contact means 12 at one lateral side of the connecting element 6 and the contact pieces 7 are interconnected with the contact means 12 via suitable connecting means (e.g. a copper bar with a main earthing bus bar) arranged inside the frame. The frame is provided with four wheels arranged in such a manner to be driven on a pair of guiding rails 11 attached parallel to each other at opposing side walls of the casing 5.

An earthing strip forming one of the earthing contacts protrudes from the casing 5 at a point where it may be inserted into the contact means 12 by simply driving the connecting element 6 on the guiding rails 11 into the position in which the connecting element 6 has got its contact pieces 7 connected to the first current inlet/outlet system 1.

To prevent any accidental movement of the connecting element 6 out of the operating position a locking device may be provided at the connecting element 6 and/or at the casing 5. As shown in FIG. 7, the locking device may comprise e.g a pair of spring loaded projections 10 extending sideways from the back part 8 of the connecting element 6 and being connected with a control linkage operable by means of a key. The side walls of the casing 5 are provided with a pair of matching recesses into which the spring loaded projections 10 protrude when the connecting element 6 is in the working position connected to the first current inlet/outlet system 1 and the earthing contact.

The key may be a shaped end of an insulating pole which may be inserted into a complementary opening in the lock and by turning the pole the lock is opened, i.e. the projections 10 are pulled inside the back part 8 of the frame. Then the connecting element 6 may be pulled out of the casing 5 wherein the insulating pole is used as a detachable grip for a safe manipulation with the connecting element 6.

Although only the above embodiment has been described in detail as to most preferable one comprising the connecting element in the form of a slidable or drivable truck, a man skilled in the art would recognise other possible forms of the connecting element and/or of the way of driving it into contact with the first current inlet/outlet system and an earthing contact, e.g. the connecting element may be arranged permanently inside the casing and movable between a working position and a disconnected position. The connecting element may be even hinged to the casing and then the movement of the connecting element between the operating position and the disconnected position may be realized by swivelling the connecting element around a vertical or horizontal or otherwise arranged axis. In that case the connecting element may be connected to an earthing contact permanently. The lock, too, may be constructed in other ways e.g. as a detent arranged pivotally or slidingly at the casing and adapted to engage the back part 8 and/or front part 9 of the connecting element 6 when in the working position.

The connecting element 6 and/or the circuit breaker 3 may be provided with driving mechanisms for moving them in the required positions. It is also possible to use a portable short-circuiting device as the connecting element 6.

Although it is preferable that the circuit breaker is movable and the two current inlet/outlet systems 1, have a fixed position inside the casing it is also possible to arrange the two current inlet/outlet systems 1, 2 movably and the circuit breaker 3 in a fixed position. Another possible embodiment comprises a movably arranged circuit breaker 3 and the two current inlet/outlet systems 1, 2, one of them movably arranged and the other one stationary.

The earthing strip forming the earthing contact may be formed long enough to be ready for the contact with the contact means 12 at one point as well as for the contact with the circuit breaker 3 at another point. A preferred embodiment comprises two individual earthing contacts, one for the contact with the contact means 12 and the other for the contact with the circuit breaker 3.

The preferred embodiment of a medium or high voltage switchgear apparatus described above comprises cables as the first current inlet/outlet system and bus bars as the second current inlet/outlet system. However, it is possible that both current inlet/outlet systems are formed by cables or by bus bars or that the first current inlet/outlet system is formed by bus bars and the second current inlet/outlet system is formed by cables.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method of earthing a first and a second current inlet/outlet systems in a medium or high voltage switchgear comprising a circuit breaker, the method comprising:
a) switching OFF the circuit breaker;
b) connecting the circuit breaker to the first current inlet/outlet system as well as to an earthing contact;
c) switching the circuit breaker ON;
d) providing a direct connection between the first current inlet/outlet system and an earthing contact via a connecting element;
e) switching the circuit breaker OFF;
f) disconnecting the circuit breaker at least from the first current inlet/outlet system;
g) connecting the circuit breaker between the second current inlet/outlet system and an earthing contact; and
h) switching the circuit breaker ON.

2. The method according to claim 1, wherein the first current inlet/outlet system is formed by several mutually electrically connected cables, the second current inlet/outlet system is formed by several bus bars and the circuit breaker is a vacuum interrupter.

3. The method according to claim 1, wherein the connecting element comprises a frame which is provided with one or more contact pieces at its front part to be connected to the first current inlet/outlet system and with one or more contact means to be connected to an earthing contact, wherein each of said one or more contact pieces is electrically connected with the contact means and said providing a direct connection between the first current inlet/outlet system and an earthing contact via a connecting element comprises inserting the connecting element into the switchgear.

4. The method according to claim 3, wherein the switchgear comprises a casing and two guiding rails attached parallel to each other at opposite side walls of the casing wherein providing a direct connection between the first current inlet/outlet system and an earthing contact via a connecting element comprises grasping the connecting element using an insulating rod and sliding the connecting element on the guiding rails until said one or more contact pieces are connected to the first current inlet/outlet system and said one or more contact means are connected to an earthing contact.

5. A medium or high voltage switchgear apparatus for making and breaking connection between a first and a second current inlet/outlet system, the apparatus comprising a casing, inside which a first current inlet/outlet system, a second current inlet/outlet system, one or more earthing contacts and a circuit breaker are disposed, wherein the circuit breaker is movable relative to the first and to the second current inlet/outlet system to a position in which the circuit breaker is connected between the first current inlet/outlet system and the second current inlet/outlet system, to another position in which the circuit breaker is connected between the first current inlet/outlet system and an earthing contact, and to yet another position in which the circuit breaker is connected between the second current inlet/outlet system and an earthing contact, whereas the apparatus further comprises a movable connecting element for making a connection between the first current inlet/outlet system and an earthing contact when the circuit breaker is switched ON and connected between the first current inlet/outlet system and an earthing contact and for keeping the connection after the circuit breaker has been switched OFF and disconnected at least from the first current inlet/outlet system.

6. The medium or high voltage switchgear apparatus according to claim 5, wherein the first current inlet/outlet system is formed by several mutually electrically connected cables, the second current inlet/outlet system is formed by several bus bars provided with several tee-offs and the circuit breaker is a vacuum interrupter.

7. The medium or high voltage switchgear apparatus according to claim 5, wherein the circuit breaker and/or the connecting element is provided with a driving mechanism for moving the circuit breaker to the required positions.

8. The medium or high voltage switchgear apparatus according to claim 5, wherein the connecting element comprises a frame which comprises one or more contact pieces at its front part to be connected to the first current inlet/outlet system and at least one laterally arranged contact means to be connected to an earthing contact, wherein each of said one or more contact pieces are electrically connected with the contact means.

9. The medium or high voltage switchgear apparatus according to claim 8, wherein there are two guiding rails attached parallel to each other at the side walls of the casing and the connecting element comprises at least two sliding areas or at least two wheels for sliding or driving the connecting element in the required positions.

10. The medium or high voltage switchgear apparatus according to claim 5 wherein a locking device is provided at the connecting element and/or at the casing for locking the connecting element in the position in which the locking device is connected to the first current inlet/outlet system and to the earthing contact.

11. The medium or high voltage switchgear apparatus according to claim 10, wherein the locking device comprises at least one spring loaded projection extending sideways from the back part of the connecting element and being connected with a control linkage operable by means of a key, wherein the casing and/or the rails are provided with at least one recess accommodating the projection when the connecting element is locked connected to the first current inlet/outlet system and to the earthing contact.
